(19) United States
(12) Patent Application Publication
(10) Pub. No.: US 2006/0087571 A1
(43) Pub. Date: Apr. 27, 2006

(54) Method and apparatus for performing correction in imaging device

(76) Inventor: Jung-Hyun Nam, Suwon-si (KR)

Correspondence Address: LAW OFFICE OF MONICA H CHOI, P O BOX 3424, DUBLIN, OH, 430160204, US

(21) Appl. No.: 11/129,448

(22) Filed: May 13, 2005

(30) Foreign Application Priority Data
Oct. 22, 2004 (KR) 2004-84866

(51) Int. Cl. H04N 9/64

(52) U.S. Cl. 348/246

(57) ABSTRACT

For performing image correction in an imaging device, a defect unit of the imaging device has at least one defective pixel each generating a respective defective output signal. In addition, a controller determines whether to correct image output signals from an image pixel array of the imaging device depending on the at least one defective output signal from the defect unit. The defect unit is fabricated in a dark region of the imaging device with the respective defective output signal varying with temperature.

### BACKGROUND OF THE INVENTION

This application claims priority to Korean Patent Application No. 2004-84866, filed on Oct. 22, 2004 in the Korean Intellectual Property Office, the disclosure of which is incorporated herein in its entirety by reference.

1. Field of the Invention

The present invention relates generally to imaging devices, and more particularly, to a method and apparatus for performing correction for defective pixels in an imaging device.

2. Description of the Related Art

In general, imaging devices convert an optical image into electrical signals. Examples of such imaging devices include charge coupled devices (CCDs) and complementary metal oxide semiconductor (CMOS) image sensors.

A CCD includes a plurality of metal oxide semiconductor (MOS) capacitors arranged in an array. Electrical charges (carriers) are stored in each of the MOS capacitors. A CMOS imaging device is comprised of a plurality of pixels each having a photodiode. The pixels are driven by a control circuit through various signal processing operations. Currently, CMOS image sensors, which are integrated into one chip with other devices and are easily manufactured using CMOS technology, have been widely used in various fields.

A photodiode in a pixel of a CMOS imaging device converts an intensity of light sensed by the photodiode into an electrical signal. The electrical signals from an array of photodiodes form an image.

However, such photodiodes are prone to various defects caused by contamination, operation errors, or substrate defects. The output signal of a defective pixel is different from the output signal of a non-defective pixel, and thus, a defective pixel is easily discernible from display on a screen.

Referring to FIG. 1, the magnitude of a signal output from a defective pixel is generally higher than the magnitude of a signal output from a non-defective pixel. The signal from a defective pixel is displayed on a screen as a white dot especially at low illumination, and such a defective pixel is referred to as a dark defect.

In general, correction for all dark defects is difficult, and thus, minor dark defects are ignored sometimes. Various methods of correcting for defective pixels have been suggested. Of those methods, defect correction methods disclosed in U.S. Pat. No. 6,396,589 and Korean Patent Gazette No. 2000-44543 is now described.

In U.S. Pat. No. 6,396,589, an imaging device is tested for defects. The locations of defective pixels as determined during the test process are memorized. Thereafter, when the imaging device outputs an image, signals output from the memorized locations are replaced with signals output from other locations near the memorized locations. In this prior art method, the imaging device uses a device for storing the locations of the defective pixels and a shutter for excluding light, resulting in increased manufacturing cost.

In Korean Patent Gazette No. 2000-44543, defective pixels within an imaging device are detected from an image output from the imaging device. Specifically, if an output signal of a pixel is different from output signals of neighboring pixels, such a pixel is determined to be a defective pixel such that the output signal of the defective pixel is replaced with an output signal of a neighboring pixel. Thus, the imaging device is not adjusted for each field and does not use a memory device nor a shutter, resulting in reduced manufacturing cost.

However, in such a prior art method, a non-defective pixel may be mistakenly determined as a defective pixel especially at high illumination and then undesirably corrected, thus causing image distortion. In general, illumination should be lowered in order to easily detect dark defects.

Dark defects 10 are easily detected as white dots at low illumination, as shown in FIG. 2A. As the illumination increases, the brightness of an image also increases. Then, the dark defects 10 may not be discernible any longer, as shown in FIG. 2B. Once the dark defects 10 are detected, the dark defects 10 are removed from a screen by replacing signals for such dark defects 10 with signals from adjacent non-defective pixels, as shown in FIG. 3A.

In the prior art method however, white dots on an image may be erroneously determined as dark defects. When signals for such erroneously determined dark defects are replaced with signals from adjacent non-defective pixels, image distortion results. In this regard, removal of dark defects detected at high illumination is more likely to cause distortion than the removal of dark defects detected at low illumination. For example, FIG. 3A illustrates removal of dark defects at low illumination, and 3B illustrates removal of dark defects at high illumination.

In addition, temperature affects level of a signal output from a pixel, with a higher temperature generally resulting in a higher level of signal output from the pixel. Thus, a mechanism is desired for performing image correction in an image device that accounts for the level of illumination and temperature.

### SUMMARY OF THE INVENTION

In a method and apparatus for performing image correction in an imaging device, a defect unit of the imaging device has at least one defective pixel each generating a respective defective output signal. In addition, a controller determines whether to correct image output signals from an image pixel array of the imaging device depending on the at least one defective output signal from the defect unit.

The defect unit is fabricated near the image pixel array on a same semiconductor substrate. In addition, the defect unit is fabricated in a dark region of the imaging device with the respective defective output signal varying with temperature.

In another embodiment of the present invention, the defect unit is comprised of a plurality of defective pixels, and the controller averages the defective output signals to generate an average defective output signal. The controller then controls a correction unit to correct the image output signals if the average defective output signal is greater than a threshold. On the other hand, the controller disables the correction unit such that the image output signals from the image pixel array are output without correction if the average defective output signal is not greater than the threshold.

In an example embodiment of the present invention, a defective pixel in the defective unit is comprised of an n-type semiconductor region without an adjacent p-type semiconductor region. Alternatively, a defective pixel in the defective unit is comprised of an n-type semiconductor region, a p-type semiconductor region formed adjacent the n-type semiconductor region, and a high concentration impurity region formed through the n-type and p-type semiconductor regions.

In this manner, the defect unit that is fabricated in the dark region accurately determines an impact of a pixel defect on the image output signals depending on temperature. Thus, correction is performed on the image output signals for defective pixels in the image pixel array when such impact is determined to be significant enough such that image distortion is minimized.

### BRIEF DESCRIPTION OF THE DRAWINGS

The above and other features and advantages of the present invention will become more apparent when described in detailed exemplary embodiments thereof with reference to the attached drawings in which:

FIG. 1 is a plot of a magnitude of a signal output from a defective pixel and a magnitude of a signal output from a non-defective pixel;

FIG. 2A is a photograph showing a screen image with dark defects at low illumination;

FIG. 2B is a photograph showing a screen image with dark defects at high illumination;

FIG. 3A is a photograph showing a screen image after correction of the dark defects of FIG. 2A;

FIG. 3B is a photograph showing a screen image obtained after correction of the dark defects of FIG. 3A;

FIG. 4 is a block diagram of an imaging device according to an embodiment of the present invention;

FIG. 5 is a cross-sectional view of a typical photodiode;

FIG. 6 is a detailed block diagram of an image pixel array and a dark defect determination unit of FIG. 4, according to an embodiment of the present invention;

FIG. 7 is a cross-sectional view of a defective pixel as intentionally fabricated in the dark defect determination unit of FIG. 4, according to an embodiment of the present invention;

FIG. 8 is a cross-sectional view of a defective pixel as intentionally fabricated in the dark defect determination unit of FIG. 4, according to another embodiment of the present invention;

FIG. 9 is a plot of a magnitude of a signal output from an intentionally created defective pixel within the dark defect determination unit and a magnitude of a signal output from a defective pixel within the image pixel array; and

FIG. 10 is a flowchart of steps during operation of the components of FIG. 4, according to an embodiment of the present invention.

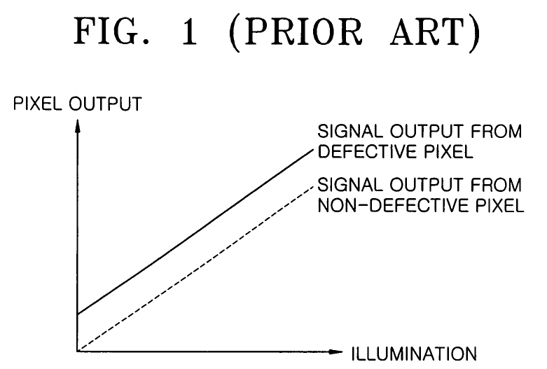

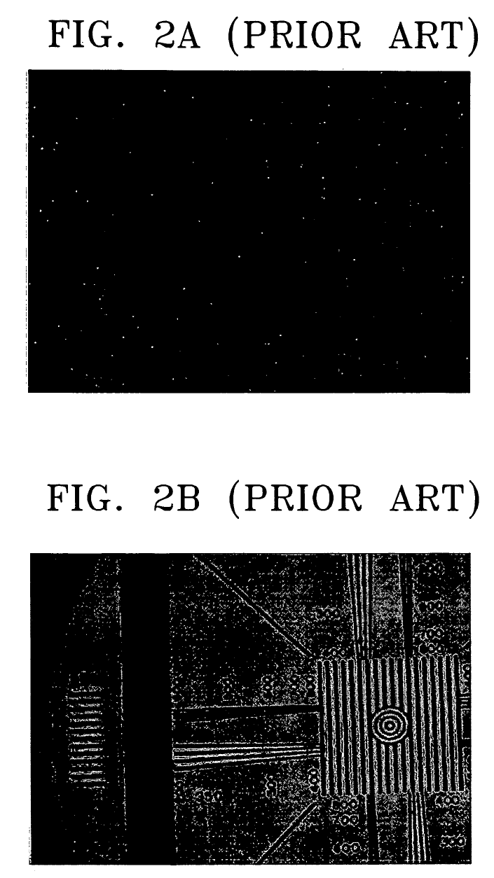

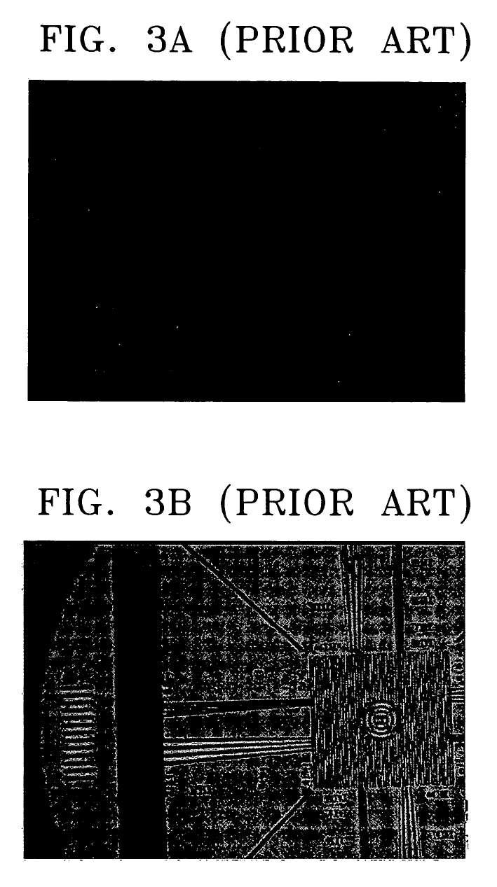

The figures referred to herein are drawn for clarity of illustration and are not necessarily drawn to scale. Elements having the same reference number in FIGS. 1, 2A, 2B, 3A, 3B, 4, 5, 6, 7, 8, 9, and 10 refer to elements having similar structure and/or function.

### DETAILED DESCRIPTION OF THE INVENTION

In general, an output signal of a defective pixel increases exponentially with temperature of the pixel. Accordingly, when the temperature is sufficiently low, the relatively low output signal of the defective pixel does not need to be corrected, even at low illumination at which dark defects appear more discernible. However, when the temperature is sufficiently high, the relatively high output signal of the defective pixel needs to be corrected, even at high illumination at which dark defects appear less discernible.

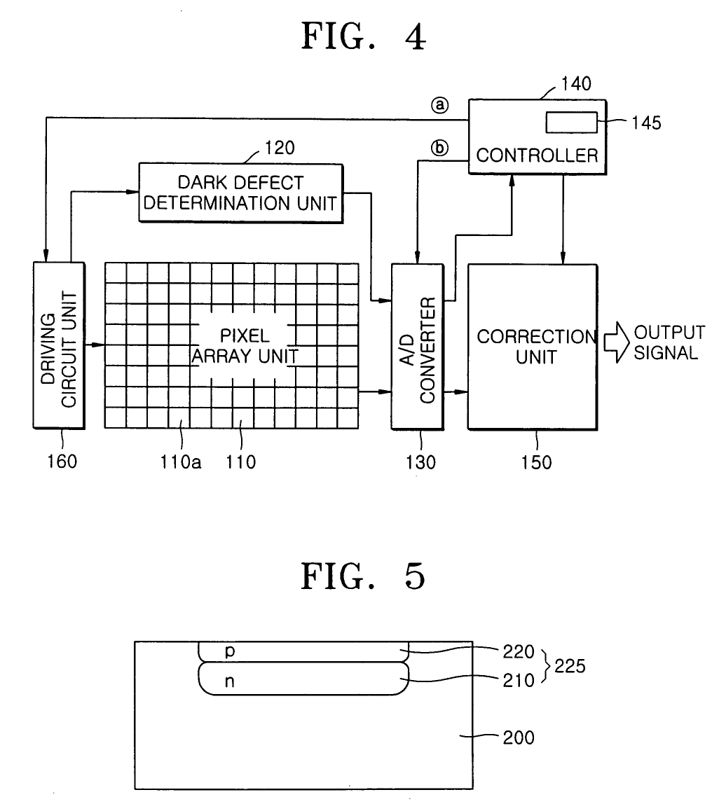

Accordingly in the present invention, a dark defect determination unit with an array of pixels with intentionally created defects is fabricated in an imaging device. Such defective pixels are fabricated with typical defects that tend to occur in an image pixel array causing dark defects. The imaging device will now be described more fully with reference to FIG. 4.

FIG. 4 is a block diagram of an imaging device according to an exemplary embodiment of the present invention. Referring to FIG. 4, the imaging device includes an image pixel array 110, a dark defect determination unit 120, an analog-to-digital (A/D) converter 130, a controller 140, a defect correction unit 150, and a driving circuit unit 160.

The image pixel array 110 is comprised of a plurality of pixels 110a. Each pixel 110a includes a photodiode (225 of FIG. 5), which is a light receiving device for sensing an external image. Referring to FIG. 5, the photodiode 225 is formed in a semiconductor substrate 200 as an n-type semiconductor region 210 and a p-type semiconductor region 220 abutting the n-type semiconductor region 210.

Thermally generated electrons accumulate in the n-type semiconductor region 210. The p-type semiconductor region 220 reduces the probability of a dark current being generated due to the thermally generated electrons in the n-type semiconductor region 210. In one embodiment of the present invention, the image pixel array 110 and the defective pixels 120a of the dark defect determination unit 120 are formed in a same semiconductor substrate 200.

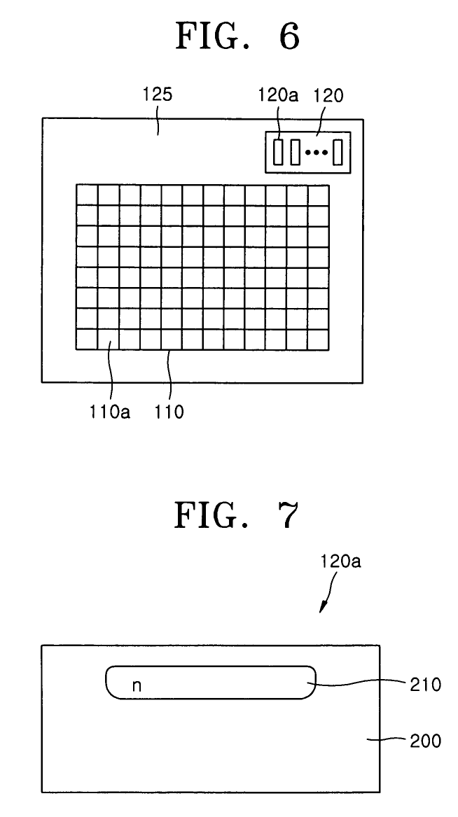

Referring to FIG. 6, the dark defect determination unit 120 is formed in an optical black region 125 surrounding the image pixel array 110. The dark defect determination unit 120 includes at least one defective pixel 120a with an intentionally created defect. The optical black region 125 is formed for offset correction and is formed with a similar environment to the image pixel array 110. However, a light shield layer (not shown) is formed on the optical black region 125 to block incident light. Thus, output signals from the defective pixels 120a in the dark defect determination unit 120 are not affected by incident light but are still affected by thermal generation of electrons in the defective pixels 120a.

FIG. 7 is a cross-sectional view of an example defective pixel 120a with an intentionally created defect in FIG. 6. Referring to FIG. 7, the defective pixel 120a includes an n-type semiconductor region 210 formed in the semiconductor substrate 200. However, the defective pixel 120a does not include a p-type semiconductor region which would prevent thermal generation of electrons. Thus, electrons are more prone to be thermally generated at the surface of the semiconductor substrate 200 in the defective pixel 120a.

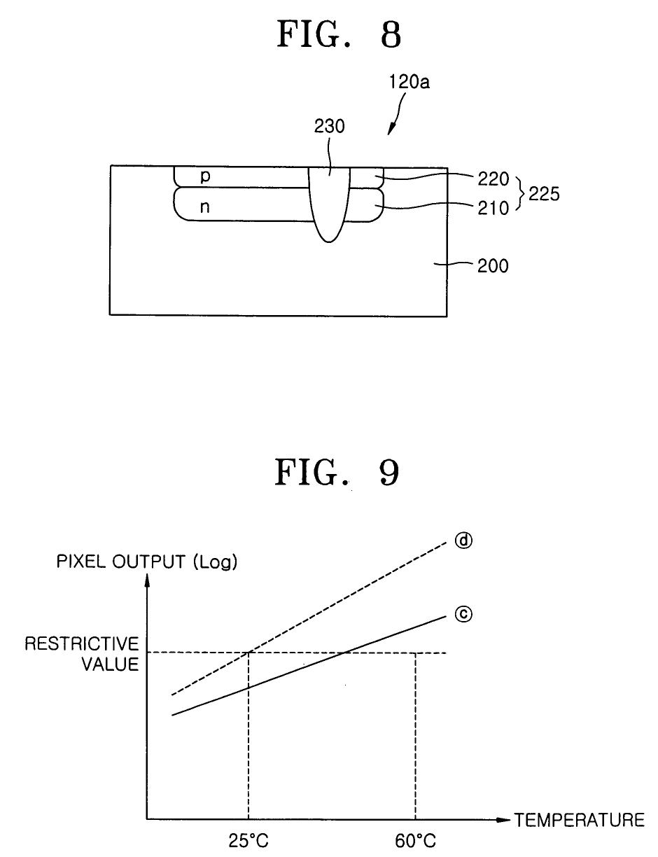

FIG. 8 is a cross-sectional view of another example defective pixel 120a with an intentionally created defect in FIG. 6. Referring to FIG. 8, the defective pixel 120a includes a photo diode 225 comprised of an n-type semiconductor region 210 and a p-type semiconductor region 220 abutting the n-type semiconductor region 210 in the semiconductor substrate 200. In addition, the defective pixel 120a also includes a high concentration impurity region 230 formed through the n-type and p-type semiconductor regions 210 and 220.

The high concentration impurity region 230 may be of an n-type or a p-type. The high concentration impurity region 230 is a source of crystalogical defects that increases electric fields and thus thermal generation in the defective pixel 120a. The defective pixel 120a has increased dark current generation and thus increased magnitude of an output signal with higher temperature.

FIG. 9 shows plots of a magnitude of an output signal from a defective pixel 120a in the dark defect determination unit 120 (plot \textcircled{c} in FIG. 9) and a magnitude of an output signal from a defective pixel within the image pixel array 110 (plot \textcircled{d} in FIG. 9), as a function of temperature. Referring to FIG. 9, plots \textcircled{c} and \textcircled{d} increase exponentially with temperature. However, plot \textcircled{c} is lower than plot \textcircled{d}. Therefore, the present invention determines whether to correct output signals from the pixels 110a of the image pixel array 110 depending on output signals from defective pixels 120a in the dark defect determination unit 120, as now described in the following.

Referring to FIG. 4, the A/D converter 130 converts analog signals output from the image pixel array 110 and the dark defect determination unit 120 into digital signals to be processed in a digital system. The controller 140 receives the digitized output signals of the image pixel array 110a and the dark defect determination unit 120 and controls the operation of the correction unit 150 based on such received signals.

For example, the controller 140 determines whether the output signals from the pixels 110a in the image pixel array 110 are corrected based on output signals from the defective pixels 120a in the dark defect determination unit 120. In addition, the controller 140 generates an accumulation time adjustment signal \textcircled{a} based on the output signals from the image pixel array 110 and the dark defect determination unit 120. Such an accumulation time adjustment signal \textcircled{a} is sent to the driving circuit unit 160 that provides driving signals to the image pixel array 110 according to the accumulation time adjustment signal \textcircled{a}.

In addition, the controller 140 generates an amplification gain adjustment signal \textcircled{b} based on the output signals of the image pixel array 110 and the dark defect determination unit 120. Such an amplification gain adjustment signal \textcircled{b} is sent to the A/D converter 130 that uses the amplification gain adjustment signal \textcircled{b} during A/D conversion of the output signals from the image pixel array 110 and the dark defect determination unit 120.

The correction unit 150 is turned on or off in response to a driving signal output from the controller 140. When the correction unit 150 is turned on by the controller 140, the correction unit 150 performs dark defect correction on an output signal of a defective pixel in the image pixel array 110 by replacing such an output signal with another output signal from a pixel adjacent to the defective pixel. Alternatively, the correction unit 150 is turned off to be disabled such that the correction unit 150 does not perform dark defect correction on output signals from the image pixel array 110.

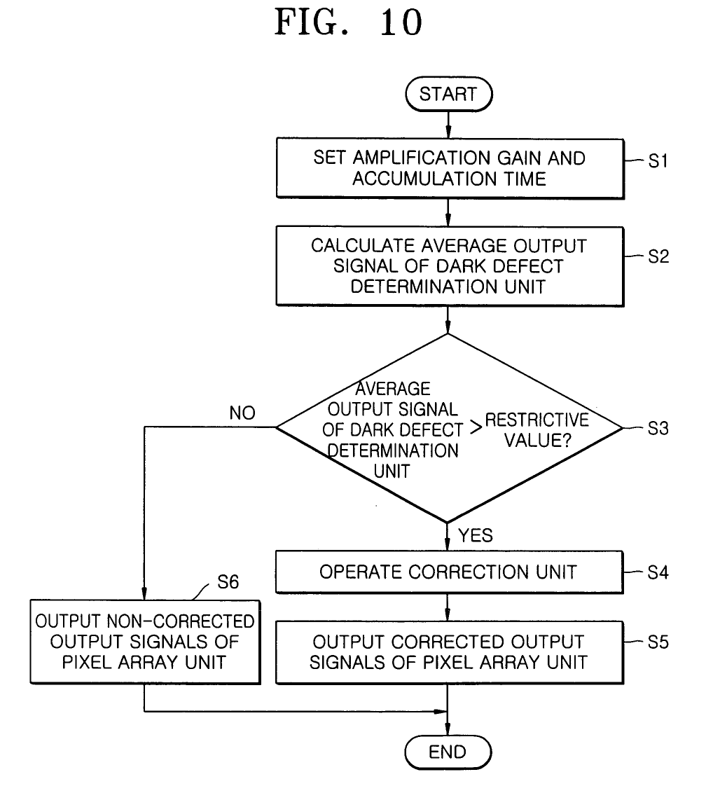

The operation of the imaging device of FIG. 4 is now described in further detail with reference to FIG. 10 which is a flow-chart of steps during operation of the imaging device of FIG. 4. Referring to FIGS. 4 and 10, when the image pixel array 110 photographs each frame, the controller 140 sets the accumulation time and the amplification gain for the driving circuit unit 160 and the A/D converter 130, respectively, based on an image of a previous frame (step S1 of FIG. 10).

The driving circuit unit 160 generates and applies driving signals depending on the accumulation time to the image pixel array 110 and the dark defect determination unit 120. The image pixel array 110 photographs each frame in response to such driving signals from the driving circuit unit 160. In addition, each defective pixel 120a in the dark defect determination unit 120 generates a dark current in response to the driving signals from the driving circuit unit 160.

When the image pixel array 110 completes the photographing of one frame, defective output signals from the dark defect determination unit 120 are addressed to be sequentially transmitted to the A/D converter 130. Thereafter, the addressed defective output signals of the dark defect determination unit 120 are converted into digital signals by the A/D/ converter 130, and such digital signals are transmitted to the controller 140.

Subsequently, the controller 140 calculates an average defective output signal by averaging the digitized defective output signals of the dark defect determination unit 120 (step S2 in FIG. 10). A comparator 145 within the controller 140 compares the average defective output signal of the dark defect determination unit 120 with a threshold value set in advance (step S3 in FIG. 10). The threshold value is a minimum pixel output signal required for turning on the correction unit 150.

If the average defective output signal of the dark defect determination unit 120 is greater than the threshold value, the controller 140 drives the correction unit 150 to perform correction on an image output signal of any defective pixel 110a in the image pixel array 110 (step S4 of FIG. 10). Consequently, the correction unit 150 replaces an image output signal of a defective pixel 110a in the image pixel array 110 with another image output signal of an adjacent non-defective pixel within the image pixel array 110 (step S4 of FIG. 10). In this manner, image output signals of defective pixels in the image pixel array 110 are corrected by the correction unit 150 and then output to represent the image photographed by the image pixel array 110 (step S5 of FIG. 10).

On the other hand, if the average defective output signal of the dark defect determination unit 120 is not greater than the threshold value, the controller 140 decides that the image output signals of the pixels 110a in the image pixel array 110 are not high enough to be corrected. In that case, the controller 140 disables the correction unit 150 such that the image output signals of the pixels 110a in the image pixel array 110 are output to be imaged without being corrected by the correction unit 150. In an example embodiment of the present invention, output signals of the dark defect determination unit 120 may be detected during a vertical blanking time between the processing of one frame and the processing of another frame from the image pixel array 110.

In this manner, the dark defect determination unit 120 that is fabricated in the dark region accurately determines an impact of a pixel defect on the output signals of the image pixel array 110 depending on temperature. Thus, correction is performed on the output signals for defective pixels in the image pixel array 110 when such impact is determined to be significant enough such that image distortion is minimized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of performing image correction in an imaging device, comprising:
generating a respective defective output signal from at least one defective pixel within a defect unit of the imaging device; and
determining whether to correct image output signals from an image pixel array of the imaging device depending on the at least one defective output signal from the defect unit.

2. The method of claim 1, further comprising:
fabricating the defect unit near the image pixel array on a same semiconductor substrate.

3. The method of claim 1, further comprising:
fabricating the defect unit with a plurality of defective pixels;
averaging the respective defective output signals to generate an average defective output signal; and
correcting the image output signals from the image pixel array if the average defective output signal is greater than a threshold.

4. The method of claim 3, further comprising:
outputting the image output signals from the image pixel array without correction if the average defective output signal is not greater than the threshold.

5. The method of claim 1, further comprising:
forming the defect unit in a dark region of the imaging device, wherein the respective defective output signal varies with temperature.

6. The method of claim 1, wherein a defective pixel in the defective unit is comprised of an n-type semiconductor region without an adjacent p-type semiconductor region.

7. The method of claim 1, wherein a defective pixel in the defective unit is comprised of an n-type semiconductor region, a p-type semiconductor region formed adjacent the n-type semiconductor region, and a high concentration impurity region formed through the n-type and p-type semiconductor regions.

8. An apparatus for performing image correction in an imaging device, comprising:
a defect unit of the imaging device having at least one defective pixel each generating a respective defective output signal; and
a controller for determining whether to correct image output signals from an image pixel array of the imaging device depending on the at least one defective output signal from the defect unit.

9. The apparatus of claim 8, wherein the defect unit is disposed near the image pixel array on a same semiconductor substrate.

10. The apparatus of claim 8, further comprising:
a correction unit, wherein the defect unit is comprised of a plurality of defective pixels, and wherein the controller averages the defective output signals to generate an average defective output signal for controlling the correction unit to correct the image output signals if the average defective output signal is greater than a threshold.

11. The apparatus of claim 10, wherein the controller disables the correction unit such that the image output signals from the image pixel array are output without correction if the average defective output signal is not greater than the threshold.

12. The apparatus of claim 8, wherein the defect unit is formed in a dark region of the imaging device, and wherein the respective defective output signal varies with temperature.

13. The apparatus of claim 8, wherein a defective pixel in the defective unit is comprised of an n-type semiconductor region without an adjacent p-type semiconductor region.

14. The apparatus of claim 8, wherein a defective pixel in the defective unit is comprised of an n-type semiconductor region, a p-type semiconductor region formed adjacent the n-type semiconductor region, and a high concentration impurity region formed through the n-type and p-type semiconductor regions.

15. An imaging device comprising:
an image pixel array for converting an image into image output signals;
a defect unit formed in a dark region of the imaging device and having at least one defective pixel each generating a respective defective output signal; and
a controller for determining whether to correct the image output signals depending on the at least one defective output signal from the defect unit.

16. The imaging device of claim 15, wherein the defect unit is disposed near the image pixel array on a same semiconductor substrate.

17. The imaging device of claim 15, further comprising:
a correction unit, wherein the defect unit is comprised of a plurality of defective pixels, and wherein the controller averages the defective output signals to generate an average defective output signal for controlling the correction unit to correct the image output signals if the average defective output signal is greater than a threshold.

18. The imaging device of claim 17, wherein the controller disables the correction unit such that the image output signals from the image pixel array are output without correction if the average defective output signal is not greater than the threshold.

19. The imaging device of claim 15, wherein a defective pixel in the defective unit is comprised of an n-type semiconductor region without an adjacent p-type semiconductor region.

20. The imaging device of claim 15, wherein a defective pixel in the defective unit is comprised of an n-type semiconductor region, a p-type semiconductor region formed adjacent the n-type semiconductor region, and a high concentration impurity region formed through the n-type and p-type semiconductor regions.
